(19) United States
(12) Patent Application Publication
(10) Pub. No.: US 2006/0044217 A1
(43) Pub. Date: Mar. 2, 2006

(54) Image providing system and method thereof

(75) Inventors: Young-sang Kim, Suwon-si (KR); Kun-tae Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/199,991

(22) Filed: Aug. 10, 2005

(30) Foreign Application Priority Data
Aug. 24, 2004 (KR) 10-2004-0066785

(51) Int. Cl. G09G 5/00

(52) U.S. Cl. 345/2.1

(57) ABSTRACT

An image providing system and a method thereof, wherein the image providing system includes a host device for receiving video signals from video input sources and for processing the received video signals, a wireless display device, connected wirelessly to the host device, for displaying an image corresponding to a first of the processed video signals if the first video signal is received, and a wire-based display device, connected by wire to the host device, for displaying an image corresponding to a second of the processed video signals that is different from the first video signal if the second video signal is received. Accordingly, many users can view different images using a plurality of display devices of one image providing system.

This application claims benefit under 35 U.S.C. § 119 from Korean Patent Application No. 10-2004-0066785, filed on Aug. 24, 2004, the entire content of which is incorporated herein by reference.

### BACKGROUND OF THE INVENTION

1. Field of the Invention

The present invention relates to an image providing system and a method thereof, and more particularly to an image providing system and a method thereof that can display a plurality of analog video signals or a plurality of digital video signals input from a plurality of external video input sources.

2. Description of the Related Art

An image providing system is a system that provides images to viewers through wire-based/wireless channels. The image providing system includes a host device and one or more display devices. The host device receives various kinds of analog video signals or digital video signals from external video input sources, and transmits the video signals to the corresponding display device after processing the video signals, so that the corresponding display device displays the video signals. The at least one display device may be a wireless display device or a wired display device. With the development of wireless communication technologies, image providing systems have widely been spread. Accordingly, a user can locate a wired/wireless display device, and particularly a wireless display device, in a certain place, and can view an image displayed on the display device irrespective of the location.

If a conventional image providing system as described above receives an analog video signal or a digital video signal from an external video input source and displays the corresponding image through a plurality of display devices, the same image provided from the external video input source is displayed on each of the plurality of display devices. However, in the event that plural display devices are used by different users, it is undesirable that the same image is displayed through each of the respective display devices since the respective users have different tastes.

For example, in the event that one display device is used by adults and another display device is used by children, the adults may want to view a movie while the children may intend to view a broadcast. However, since conventional image providing systems can only display the same image through each of the respective display devices, separate systems must be provided in order for the respective users to view their desired images.

### SUMMARY OF THE INVENTION

Illustrative, non-limiting embodiments of the present invention have been developed in order to solve the above drawbacks and other problems not described above associated with conventional arrangements. Also, the present invention is not required to overcome the above drawbacks described above, and an illustrative, non-limiting embodiment of the present invention may not overcome any of the drawbacks described above. An aspect of the present invention is to provide an image providing system and a method thereof that can transmit various kinds of video signals input from a plurality of external video input sources to a plurality of display devices so that different images can be provided to the respective display devices.

The foregoing and other objects and advantages are substantially realized by providing an image providing system, according to an exemplary embodiment of the present invention, which comprises a host device for receiving at least two video signals from at least two video input sources and processing the received video signals, a wireless display device, connected by wireless to the host device, for displaying an image corresponding to one of the processed video signals if the one video signal is received, and a wired display device, connected by wire to the host device, for displaying an image corresponding to another of the processed video signals that is different from the one video signal if the other video signal is received.

It is preferable, but not necessary, that the host device includes a tuner for receiving, by wireless, digital broadcasting signals and analog broadcasting signals from the video input sources, a wireless interface connected by wireless to the wireless display device, a wire interface connected by wire to the wired display device, and a switching unit for performing a switching operation in a manner that it provides one of the digital broadcasting signals and the analog broadcasting signals to the wireless interface as the one video signal and provides another of the digital broadcasting signals and the analog broadcasting signals that is different from the one broadcasting signal to the wire interface as the other video signal.

It is preferable, but not necessary, that the host device further includes an external input terminal for receiving an input of at least one wired video input signal from the wired video input sources connected by wire to the host device among the at least two video input sources, and the switching unit performs a switching operation in a manner that it selects the one video signal among the digital broadcasting signals, the analog broadcasting signals and the at least one wired video input signal, and selects the other video signal among the digital broadcasting signals, the analog broadcasting signals and the at least one wired video input signal.

It is also preferable, but not necessary, that that the host device includes an external input terminal for receiving an input of at least two wired video input signals from the wired video input sources connected by wire to the host device among the at least two video input sources, a wireless interface connected by wireless to the wireless display device, a wire interface connected by wire to the wired display device, and a switching unit for performing a switching operation in a manner that it provides one of the at least two wired video input signals to the wireless interface as the one video signal and provides another of the at least two wired video input signals that is different from the one broadcasting signal to the wire interface as the other video signal.

It is also preferable, but not necessary, that the host device further includes a tuner for receiving by wireless at least one broadcasting signal among digital broadcasting signals and analog broadcasting signals from the video input sources, and the switching unit performs a switching operation in a manner that it selects the one video signal among the at least one broadcasting signal and the at least two wired video input signals, and selects the other video signal among the at least one broadcasting signal and the at least two wired video input signals.

The wireless display device may include a user input unit for receiving an input of a selection command for the one video signal and the other video signal among the at least two processed video signals, a second wireless interface connected by wireless to the host device, and a second control unit for controlling to transmit information based on the selection command for the one video signal and the other video signal to the host device through the second wireless interface, and the host device transmits the one video signal to the wireless display device based on the transmitted information and transmits the other video signal to the wired display device.

The wireless display device may include a display unit, a user input unit, a menu view generating unit for generating a menu view provided for selection of the one video signal and the other video signal among the at least two processed video signals, and a second control unit for controlling the menu view generating unit to generate the menu view and controlling the display unit to display the menu view if a display command of the menu view is input through the user input unit.

It is preferable, but not necessary, that the wireless display device further includes a second wireless interface connected by wireless to the host device, and the second control unit controls to transmit the information based on the selection command for the one video signal and the other video signal to the host device through the second wireless interface if the selection command for the one video signal and the other video signal among the at least two video signals based on the displayed menu view is input through the user input unit, and the host device transmits the one video signal to the wireless display device and transmits the other video signal to the wired display device based on the transmitted information.

In another aspect of the present invention, there is provided an image providing method, which comprises the operations of (a) receiving at least two video signals from at least two video input sources and processing the received video signals, (b) displaying an image corresponding to one of the processed video signals if the one processed video signal is transmitted by wireless, and (c) displaying an image corresponding to another of the processed video signals that is different from the one processed video signal if the one processed video signal and the other processed video signal among the at least two video signals are transmitted by wire.

Accordingly, many users can view different images using a plurality of display devices of one image providing system.

### BRIEF DESCRIPTION OF THE DRAWINGS

The above aspects and features of the present invention will become more apparent by describing certain illustrative, non-limiting embodiments of the present invention with reference to the accompanying drawings, in which:

FIG. 1 is a view schematically illustrating an image providing system according to an exemplary embodiment of the present invention;

FIG. 2 is a block diagram of a host device of FIG. 1;

FIG. 3 is a block diagram of a wireless display device of FIG. 1;

FIG. 4 is a view illustrating an input source menu view according to an exemplary embodiment of the present invention; and

FIG. 5 is a flowchart illustrating an image providing method according to an exemplary embodiment of the present invention.

### DETAILED DESCRIPTION OF THE EXEMPLARY EMBODIMENTS OF THE PRESENT INVENTION

Certain illustrative, non-limiting embodiments of the present invention will be described in greater detail with reference to the accompanying drawings.

In the following description, the same drawing reference numerals are used to denote the same elements even in different drawings. The matters defined in the description, such as a detailed construction and elements, are merely examples provided to assist in a comprehensive understanding of the present invention. Thus, it is apparent that the present invention can be carried out without those defined matters. Also, well-known functions or constructions are not described in detail since they would obscure the invention in unnecessary detail.

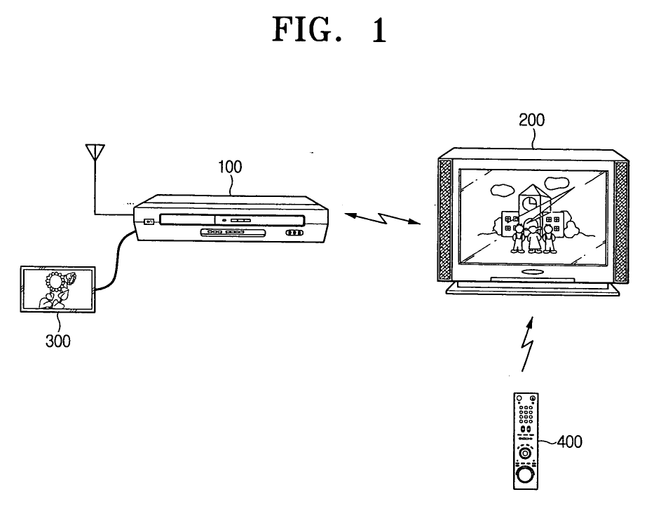

FIG. 1 is a view schematically illustrating an image providing system according to an exemplary embodiment of the present invention.

Referring to FIG. 1, an image providing system according to an exemplary embodiment of the present invention includes a host device 100, a wireless display device 200 and a wired display device 300.

The host device 100, for example, receives video signals from input sources (hereinafter referred to as “wired video input sources”) that provide digital broadcasting signals, analog broadcasting signals and wired video signals to the host device, processes and outputs the video signals to the wireless display device 200 and the wired display device 300. For this, the host device 100 is connected by wire to the wired display device 300, and is connected wirelessly to the wireless display device 200.

The host device 100 processes the video signals input from the different external video input sources based on a user's selection so as to output the video signals through the wireless display device 200 and the wired display device 300 as different images. In this particular exemplary embodiment of the present invention, the user's selection refers to a command input to the wireless display device 200 through a remote controller 400. The wireless display device 200 transmits information based on the input command to the host device 100, and the host device 100 performs a corresponding operation.

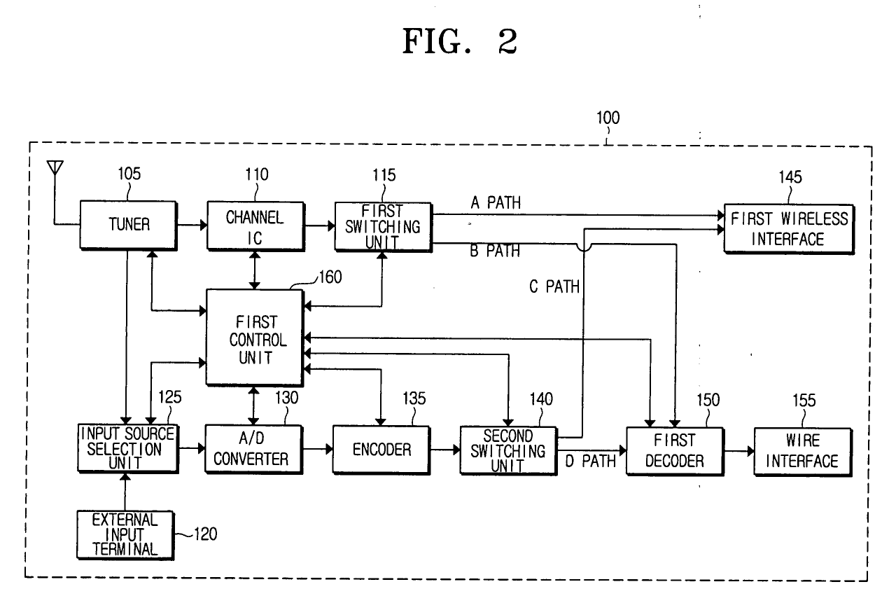

FIG. 2 is a block diagram of the host device of FIG. 1 consistent with an exemplary embodiment of the present invention. The host device 100 includes a tuner 105, a channel IC 110, a first switching unit 115, an external input terminal 120, an input source selection unit 125, an analog-to-digital (A/D) converter 130, an encoder 135, a second switching unit 140, a first wireless interface 145, a first decoder 150, a wire interface 155, and a first control unit 160.

The tuner 105 receives digital broadcasting signals and analog broadcasting signals from external broadcasting sources. Also, the tuner 105 tunes the channel selected among a plurality of broadcasting signals by the user under the control of the first control unit 160. If an digital broadcasting signal is received, the tuner 105 provides the received digital broadcasting signal to the channel IC 110. By contrast, if an analog broadcasting signal is received, the tuner provides the received analog broadcasting signal to the input source selection unit 125.

The channel IC 110 converts the digital broadcasting signal input from the tuner 105 into an analog broadcasting signal, encodes the converted broadcasting signal, and then generates a transport stream (TS). Hereinafter, the transport stream generated from the channel IC is called a first transport stream. The channel IC 110 provides the generated first transport stream to the first switching unit 115.

The first switching unit 115 performs a switching operation with respect to the input first transport stream under the control of the first control unit 160. That is, the first switching unit 115 transmits the first transport stream input from the channel IC 110 to either the first wireless interface 145 or the first decoder 150.

Meanwhile, the external input terminal 120 serves as an interface that receives various kinds of video signals provided from the wired video input sources. The external input terminal 120 may include an audio/video (AV) terminal, an S-video terminal, a component terminal, etc. A composite video broadcasting signal (CVBS) is input through the AV terminal, and a luminance signal (Y) and chrominance signals (Cb, Cr), which are separated from the video signal, are input through the S-video terminal. Color signals (Y, Cb, Cr) separated from the video signal are input through the component terminal. Meanwhile, the various kinds of video signals input through the external input terminal 120 are provided to the input source selection unit 125.

The input source selection unit 125 selects from the analog broadcasting signals provided from the tuner 105 and the various kinds of video signals input through the external input terminal 120 and provides the selected video signal to the A/D converter 130 under the control of the first control unit 160.

The A/D converter 130 performs an analog/digital conversion of the video signal selected by the input source selection unit 125. The converted digital video signal is then provided to the encoder 135.

The encoder encodes the video input signal, and generates a transport stream. Hereinafter, the transport stream generated from the encoder 135 is called a second transport stream. Specifically, the encoder encodes the converted digital signal to a compression format such as MPEG (Motion Picture Experts Group) format, and generates the second transport stream.

The second switching unit 140 performs a switching operation with respect to the input second transport stream under the control of the first control unit 160. Specifically, the second switching unit 140 transmits the second transport stream input from the encoder 135 to either the first wireless interface 145 or the first decoder 150 under the control of the first control unit 160.

The first and/or second transport stream(s) input from the first switching unit 115 and/or the second switching unit 140 through the first wireless interface 145 is/are transmitted to the wireless display device 200. In this case, a wireless LAN is used, and it is preferable, but not necessary, that the wireless LAN adopts the IEEE 802.11a standard.

The first decoder 150 decodes the transport stream(s) input from the first switching unit 115 and/or second switching unit 140 and converts the input transport stream into a displayable video signal. The converted video signal is then displayed on the wired display device 300 through the wire interface 155.

The video signal input from the first decoder 150 through the wire interface 155 is transmitted to the wired display device 300.

The first control unit 160 controls the operation of the host device 100. In an exemplary embodiment of the present invention, the first control unit 160 controls the first and second switching units 115 and 140 on the basis of the input source information transmitted from the wireless display device 200. For example, the input source information includes multi input source function setting information and output request input source selection information.

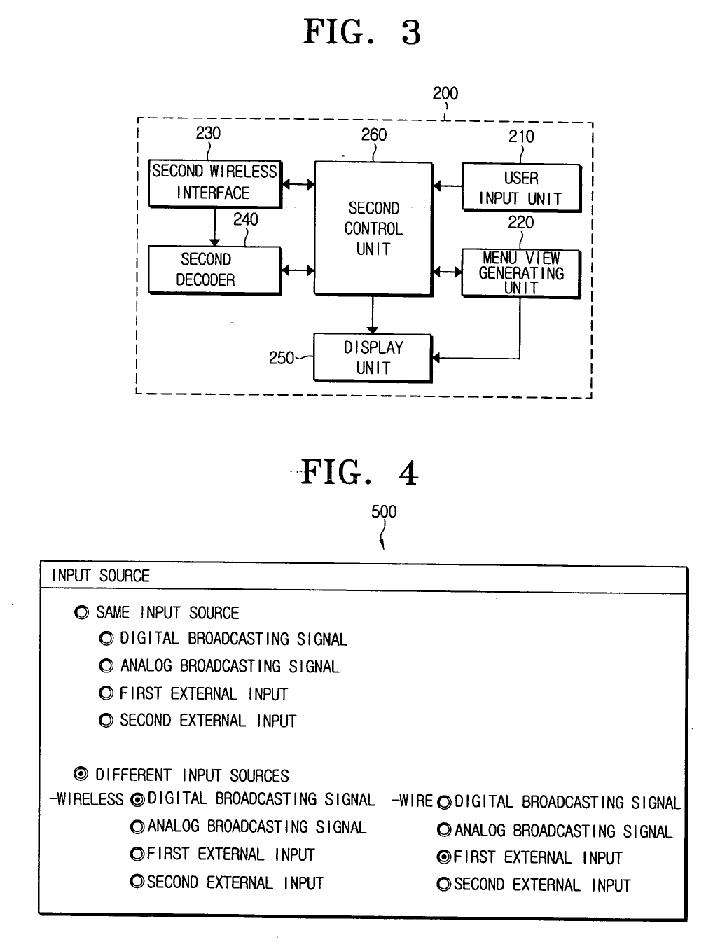

The input source information can be input based on an input source menu view 500 displayed on the display unit 250 of the wireless display device 200 as illustrated in FIG. 3 and FIG. 4. For instance, the multi input source function may refer to a function of processing a plurality of video signals from a plurality of external video input sources so that they can be displayed on a plurality of display devices in a one-to-one manner. Further, the output request input source may refer to a video input source desired to be outputted among a plurality of external video input sources, and it is preferable, but not necessary, that the number of output request input sources is set to the same as the number of wired/wireless display devices connected to the host device 100.

Hereinafter, the process of receiving an input of the multi input source function setting information and the output request input source selection information through the user input unit 210 of the wireless display device 200 (shown in FIG. 3) and controlling the first and second switching units 115 and 140 (shown in FIG. 2) through the first control unit on the basis of the input source information will be explained.

According to an exemplary embodiment of the present invention, digital broadcasting signals and analog broadcasting signals are input through the tuner 105 and the external input terminal 120 comprises the AV terminal, the S-video terminal and the component terminal, which receive corresponding video signals.

In this particular exemplary embodiment of the present invention, the first switching unit 115 and the second switching unit 140 are respectively connected to the first wireless interface 145 and the first decoder 150. Hereinafter, a connection path between the first switching unit 115 and the first wireless interface 145 is called a path A, a connection path between the first switching unit 115 and the first decoder a path B, a connection path between the second switching unit 140 and the first wireless interface 145 a path C, and a connection path between the second switching unit 140 and the first decoder 150 a path D, respectively.

First, according to one example, the multi input source function is set by the user input unit 210, a digital broadcasting signal is selected as the source of the first transport stream transmitted to the wireless display device 200, and a video signal suitable for a component terminal among the external input terminal 120 is selected as the source of the video signal transmitted to the wired display device 300.

In this case, the first control unit 160 controls the tuner 105 and the channel IC 110 to provide the first transport stream corresponding to the digital broadcasting signal to the first switching unit 115. Meanwhile, the first control unit 160 controls the input source selection unit 125 to output the video signal input through a component terminal among the analog broadcasting signal and the various kinds of video signals to the A/D converter 130. Additionally, the first control unit 160 controls the AID converter 130 and the encoder 135 to generate and provide the second transport stream corresponding to the video signal input through the component terminal to the second switching unit 140.

Then, the first control unit 160 controls the first switching unit 115 to provide the first transport stream to the first wireless interface 145. Specifically, the first control unit 160 controls the first switching unit 115 to activate the path A and to inactivate the path B. Accordingly, the first transport stream is transmitted to the wireless display device 200 through the first wireless interface 145.

Additionally, the first control unit 160 controls the second switching unit 140 to provide the second transport stream to the first decoder 150 and to provide the video signal decoded by the first decoder 150 to the wired interface 155. Specifically, the first control unit 160 controls the second switching unit 140 to inactivate the path C and to activate the path D. Accordingly, the video signal corresponding to the second transport stream is transmitted to the wired display device 300 through the wire interface 155.

Second, according to another example, the multi input source function is not set, and an analog broadcasting signal is selected as the source of the video signal transmitted to the wired display device 300 and the wireless display device 200.

In this example, the first control unit 160 controls the input source selection unit 125 to output the analog broadcasting signal, among the analog broadcasting signal and the various kinds of video signals, to the A/D converter 130. Additionally, the first control unit 160 controls the A/D converter 130 and the encoder 135 to provide a second transport stream corresponding to the analog broadcasting signal to the second switching unit 140.

Then, the first control unit 160 processes the second transport stream to be output to the wireless display device 200 through the first wireless interface 145. In this case, the first control unit 160 controls the second switching unit 140 to activate the path C. Also, the first control unit 160 processes the second transport stream to be provided to the first decoder 150. Specifically, the first control unit 160 controls the second switching unit 140 to activate the path D. Accordingly, the video signal corresponding to the second transport stream is transmitted to the wired display device 300 through the wire interface 155. Additionally, the first control unit controls the first switching unit 115 to inactivate the path A and the path B.

FIG. 3 is a block diagram of the wireless display device 200 of FIG. 1 consistent with an exemplary embodiment of the present invention. Referring to FIG. 3, the wireless display device 200 includes a user input unit 210, a menu view generating unit 220, a second wireless interface 230, a second decoder 240, a display unit 250 and a second control unit 260. Hereinafter, the wireless display device 200 as constructed above will be explained in detail with reference to FIG. 1, FIG. 2, and FIG. 3.

The user input unit 210 is a user interface that outputs a signal for requesting a function supported by the wireless display device 200 to the second control unit 260. For this, the user input unit 210 may be provided with a plurality of manipulation keys such as numeral keys, direction keys, confirmation keys, etc. The user input unit 210 may also adopt the remote controller 400 as shown in FIG. 1. According to an exemplary embodiment of the present invention, a multi input source function setting command and an output request input source selection command are input through the user input unit 210. It is preferable, but not necessary, that such commands are based on the input source menu view 500 as shown in FIG. 4. Additionally, various kinds of menu view display commands may be input through the user input unit 210, and input source menu view display commands may also be input through the user input unit 210.

The menu view generating unit 220 generates corresponding menu views based on the various kinds of menu view display commands input through the user input unit 210 and outputs the generated menu views to the display unit 250 under the control of the second control unit 260. Accordingly, the corresponding menu views are displayed on the display unit 250. In an exemplary embodiment of the present invention, the menu view generating unit 220 generates and outputs the input source menu view 500 as shown in FIG. 4 to the display unit 250.

The second wireless interface 230 is an interface, connected to the first wireless interface 145, for receiving the transport stream transmitted from the host device 100 or for transmitting various kinds of information input through the user interface 210 to the host device 100. In order for the second wireless interface 230 to communicate with the first wireless interface 145, the second wireless interface 230 should adopt the same standard as the network standard adopted by the first wireless interface 145. In an exemplary embodiment of the present invention, the second wireless interface 230 provides the transport stream from the host device 100 to the second decoder 240.

The second decoder 240 decodes the transport stream provided from the second wireless interface 230. The second decoder 240 obtains the video signal displayable on the display unit 250 through a decoding operation. The decoding algorithm used in the second decoder 240 should correspond to the encoding algorithm (for example, MPEG) used in the channel IC 110 of the host device 100.

The display unit 250 is a device that displays various kinds of menu views that include the input source menu view 500 as shown in FIG. 4 and images according to the transport streams transmitted from the host device 100. The display unit 250 may be, for example, a liquid crystal display (LCD), a plasma display panel (PDP), a cathode-ray tube (CRT), etc.

The second control unit 260 controls the operation of the wireless display device 200. The second control unit 260 controls the wireless display device 200 according to the user commands input through the user input unit 210. If the multi input source function setting command and the output request input source selection command are input via the input source menu view, the second control unit 260 operates to transmit the input source information according to the respective command to the host device 100.

FIG. 4 is a view illustrating the input source menu view according to an exemplary embodiment of the present invention.

If the input source menu view display command is input through the user input unit 210, the second control unit 260 controls the menu view generating unit 220 to display the input source menu view 500 on the display unit 250. Then, the input source menu view 500 as shown in FIG. 4 is displayed on the display unit 250. The user may set the multi input source function or select the output request input source through the user input unit 210 on the basis of the displayed input source menu view 500.

In the drawings, the selection of the term “same input source” does not refer to the setting of the multi input source function, but the selection of the term “different input sources” refers to the setting of the multi input source function. Additionally, the “digital broadcasting signal”, “analog broadcasting signal”, “first external input” and “second external input” are proposed as the video input sources. According to one exemplary embodiment, the first and second external inputs are differently adopted according to the external input terminals 120 provided to the respective image providing systems.

Additionally, as shown in FIG. 4, the multi input source function is set by selecting the term “different input sources”. As shown in FIG. 4, the “digital broadcasting signal” is selected as the source of the image output from the wireless display device 300, and the “first external input” is selected as the source of the image output from the wired display device 300. The input source information based on the selection as described above is transmitted to the host device 100 under the control of the second control unit 260.

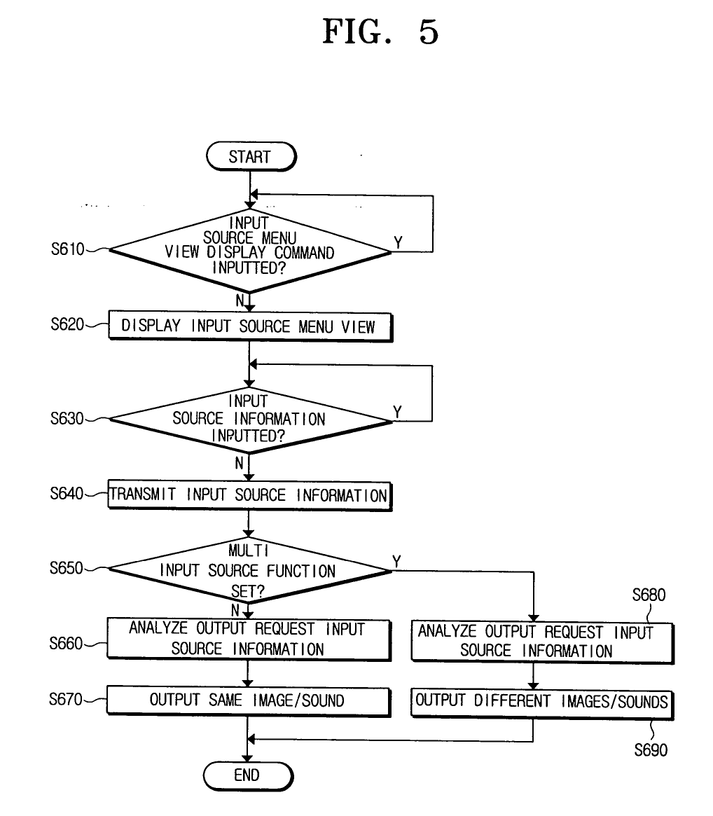

FIG. 5 is a flowchart illustrating an image providing method according to an exemplary embodiment of the present invention. The method for outputting and displaying the video signals, selected among the video signals output from the different external video input sources on the wired/wireless display devices, will now be explained.

Referring to FIG. 1, FIG. 2, FIG. 3, FIG. 4, and FIG. 5, the user first inputs the input source menu view display command to the user input unit 210 through the remote controller 400 (operation S610). Then, the wireless display device 200 displays the input source menu view 500, as shown in FIG. 4, on the display unit on the basis of the input source menu view display command (operation S620).

Then, if the user inputs whether to adopt the same/different video input source, i.e., whether to set the multi input source function and the output request input source, that is, the input source information, on the input source menu view 500 through the remote controller 400 (operation S630), the wireless display device 200 transmits the selected input source information to the host device 100 (operation S640).

The host device 100 transmits the transport stream or the video signal to the wireless display device 200 and the wired display device 300 on the basis of the transmitted input source information. This operation will now be explained in more detail.

The first control unit 160 judges whether the multi input source function is set from the input source information (operation S650).

If the multi input source function is not set as a result of judgment, the first control unit 160 analyzes the output request input source information (operation S660), and operates to output the transport stream or the video signal that corresponds to the video signal input from the corresponding external video input source according to the output request input source information to the wired display device 300 and the wireless display device 200.

In this case, the image corresponding to the video signal from the corresponding external video input source is equally output to the wired display device 300 and the wireless display device 200. For example, if the digital broadcasting signal is selected as the output request input source, the first control unit 160 controls the tuner 105, the channel IC 110 and the first switching unit 115 to transmit the first transport stream to the wireless display device 200 and the wired display device 300 through the first wireless interface 145 and the wire interface 155 so that the first transport stream is displayed on the wireless display device 200 and the wired display device 300. In this case, one output request input source would be selected.

Moreover, if two or more output request input sources are selected, and if the multi input source function is not set as a result of judgment, it may be considered that the second control unit 260 generates an error message and operates to display a generated error message on the display device 250.

By contrast, if the multi input source function is set as a result of judgment, the first control unit 160 analyzes the output request input source information (operation S680). Then, the first control unit 160 operates to output the video signals input from the external video input sources according to the result of analysis to the wired display device 300 and the wireless display device 200, respectively.

In this case, different images are output to the wired display device 300 and the wireless display device 200 (operation S690). As such, two output request input sources would be selected. More particularly, if two external video input sources are selected, the first control unit 160 analyzes whether the respective video signals output from the two selected external video input sources will be output to the wireless display device 200 or to the wired display device 300. Then, the first control unit 160 controls the host device 100, and particularly the first and second switching units, to display the video signals output from the two external video input sources on the wireless/wired display devices in accordance with the result of analysis. Additionally, if one or three or more output request input sources are selected, it may be considered that the first control unit 160 generates an error message, and processes the generated error message to be displayed on the display unit 250.

Consequently, the user can display the signals from the different external video input sources on the wireless/wired display devices, respectively, according to the user's selection.

In an exemplary embodiment of the present invention, one wired display device 300 and one wireless display device 200 are adopted as display devices. However, two or more wired display devices and/or two or more wireless display devices may also be adopted within the scope of the present invention.

Additionally, in an exemplary embodiment of the present invention, the user input device 210 is provided in the wireless display device 200, and the user can input the input source menu view display command, multi input source function setting command and output request input source selection command through the user input unit. However, the present invention is not limited thereto. That is, the user input unit may be provided in the host device 100 or the wired display device 300, and the user can input the input source menu view display command, multi input source function setting command and output request input source selection command through such a user input unit within the scope of the present invention.

Additionally, in an exemplary embodiment of the present invention, the menu view generating unit 220 is provided in the wireless display device 200. However, the menu view generating unit 220 may also be provided in the host device 100 or the wired display device 300 without departing from the scope of the present invention.

Additionally, in an exemplary embodiment of the present invention, the first and second switching units are separately provided. However, it is also possible to construct one switching unit so that it simultaneously performs the roles of the first and second switching units within the scope of the present invention.

As described above, according to the image providing system and the method thereof according to exemplary embodiments of the present invention, the user can display the same image through the wireless/wired display devices or display different images through the wireless/wired display devices according to the user's selection. Accordingly, the user can have the effect obtained by two or more image providing systems using only one image providing system. This can reduce the user's expense in implementing the image providing system.

The foregoing embodiments and advantages are merely exemplary and are not to be construed as limiting the present invention. The present teachings can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An image providing system comprising:
a host device which receives at least two video signals from at least two video input sources and processes the received video signals;
a wireless display device, connected wirelessly to the host device which, if a first of the processed video signals is received, displays an image corresponding to the first of the processed video signals; and
a wired display device, connected by wire to the host device which, if a second of the processed video signals is received, displays an image corresponding to the second of the processed video signals.

2. The image providing system as claimed in claim 1, wherein the host device comprises:
a tuner which receives wireless digital broadcasting signals and wireless analog broadcasting signals from the video input sources;
a wireless interface connected wirelessly to the wireless display device;
a wire interface connected by wire to the wired display device; and
a switching unit which performs a switching operation in such a manner that it provides a first one of the digital broadcasting signals and the analog broadcasting signals to the wireless interface as the first of the processed video signals and which provides a second one of the digital broadcasting signals and the analog broadcasting signals to the wired interface as the second of the processed video signals.

3. The image providing system as claimed in claim 2, wherein the host device further comprises an external input terminal which receives an input of at least one wired video input signal and wherein the at least one wired video input signal comprises one of the at least two video input sources;
wherein the switching unit performs a switching operation in such a manner that it selects one video signal, from among the digital broadcasting signals, the analog broadcasting signals and the at least one wired video input signal, as the first of the processed video signals, and selects a second one of the video signals, from among the digital broadcasting signals, the analog broadcasting signals and the at least one wired video input signal, as the second of the processed video signals.

4. The image providing system as claimed in claim 1, wherein the host device comprises:
an external input terminal for receiving an input of at least two wired video input signals from wired video input sources connected by wire to the host device;
a wireless interface connected wirelessly to the wireless display device;
a wire interface connected by wire to the wired display device; and
a switching unit which performs a switching operation in such a manner that it provides a first of the at least two wired video input signals to the wireless interface as the first of the processed video signals and provides a second of the at least two wired video input signals to the wired interface as the second of the processed video signals.

5. The image providing system as claimed in claim 4, wherein the host device further comprises a tuner which receives at least one wireless broadcasting signal, from among digital broadcasting signals and analog broadcasting signals, from the video input sources;
wherein the switching unit performs a switching operation in such a manner that it selects the first of the processed video signals from among the at least one wireless broadcasting signal and the at least two wired video input signals, and selects the second of the processed video signals from among the at least one wireless broadcasting signal and the at least two wired video input signals.

6. The image providing system as claimed in claim 1, wherein the wireless display device comprises:
a user input unit which receives an input of a selection command for the first of the processed video signals and the second of the processed video signals, from among the at least two processed video signals;
a second wireless interface connected wirelessly to the host device; and
a second control unit which controls transmission of information regarding the selection command for the first one of the processed video signals and the second of the processed video signals to the host device through the second wireless interface;
wherein the host device, based on the transmitted information received through the second wireless interface, transmits the first of the processed video signals to the wireless display device and transmits the second of the processed video signals to the wired display device.

7. The image providing system as claimed in claim 1, wherein the wireless display device comprises:
a display unit;
a user input unit;
a menu view generating unit which generates a menu view provided for selection of the first of the processed video signals and the second of the processed video signals, from among the at least two processed video signals; and
a second control unit which controls the menu view generating unit to generate the menu view and which controls the display unit to display the menu view if a display command for the menu view is input through the user input unit.

8. The image providing system as claimed in claim 7, wherein the wireless display device further comprises a second wireless interface connected wirelessly to the host device;
wherein the second control unit controls the transmission of information regarding the selection command for the first of the processed video signals and the second of the processed video signals to the host device through the second wireless interface if the selection command for the first of the processed video signals and the second of the processed video signals, from among the at least two video signals, is input from the user input unit through the displayed menu view; and
wherein the host device, based on the transmitted information received through the second wireless interface, transmits the first of the processed video signals to the wireless display device and transmits the second of the processed video signals to the wired display device.

9. An image providing method comprising:
receiving at least two video signals from at least two video input sources;
processing the received video signals;
if a first of the processed video signals is transmitted wirelessly, displaying an image corresponding to the first of the processed video signals; and
if the first of the processed video signals and a second of the processed video signals are transmitted by wire, displaying an image corresponding to the second of the processed video signals.

10. The image providing method as claimed in claim 9, further comprising:
receiving, wirelessly, digital broadcasting signals and analog broadcasting signals as the video input sources;
receiving an input of at least one wired video input signal from a wired video input source connected by wire to a host device, wherein said wired video input source comprises one of the at least two video input sources;
selecting the first of the processed video signals from among the digital broadcasting signals, the analog broadcasting signals and the at least one wired video input signal; and
selecting the second of the processed video signals from among the digital broadcasting signals, the analog broadcasting signals and the at least one wired video input signal.

11. The image providing method as claimed in claim 10, further comprising inputting a selection command for the first of the processed video signals and the second of the processed video signals from among the digital broadcasting signals, the analog broadcasting signals and the at least one wired video input signal;
wherein the first of the processed video signals is selected from among the digital broadcasting signals, the analog broadcasting signals and the at least one wired video input signal, and wherein the second of the processed video signals is selected from among the digital broadcasting signals, the analog broadcasting signals and the at least one wired video input signal, according to the selection command for the first of the processed video signals and the second of the processed video signals.

12. The image providing system as claimed in claim 10, further comprising:
inputting a display command of a menu view provided for selecting the first of the processed video signals and the second of the processed video signals from among the digital broadcasting signals, the analog broadcasting signals and the at least one wired video input signal;
generating the menu view according to the display command; and
inputting a selection command for the first of the processed video signals and the second of the processed video signals, from among the digital broadcasting signals, the analog broadcasting signals and the at least one wired video input signal, through the generated menu view;
wherein the first of the processed video signals is selected from among the digital broadcasting signals, the analog broadcasting signals and the at least one wired video input signal, and the second of the processed video signals is selected from among the digital broadcasting signals, the analog broadcasting signals and the at least one wired video input signal, according to information based on the selection command for the first of the processed video signals and the second of the processed video signals.
